(19) United States
(12) Patent Application Publication
(10) Pub. No.: US 2010/0028629 A1
(43) Pub. Date: Feb. 4, 2010

(54) Sealing layer for decorative layers of glass or glass-ceramic articles

(75) Inventors: Andrea Anton, Hueffelsheim (DE); Matthias Bockmeyer, Mainz (DE); Gabriele Roemer-Scheuermann, Ingelheim (DE); Hans-Joachim Schmitt, Ockenheim (DE)

Correspondence Address: OHLANDT, GREELEY, RUGGIERO & PERLE, LLP, ONE LANDMARK SQUARE, 10TH FLOOR, STAMFORD, CT, 06901, US

(73) Assignee: SCHOTT AG

(21) Appl. No.: 12/459,644

(22) Filed: Jul. 6, 2009

(30) Foreign Application Priority Data
Jul. 4, 2008 (DE) 102008031426.9-45

(51) Int. Cl. B32B 3/10

(52) U.S. Cl. 428/201

(57) ABSTRACT

The invention relates to a method for producing a glass or glass-ceramic article, comprising a decorative layer and a sealing layer. The two layers are produced by means of a sol-gel process and contain, in addition, at least fillers and inorganic pigments, wherein it is possible for the pigmentation of the decorative layer and the sealing layer to be the same or else different. In order to achieve a good adhesive strength and impermeability of the decorative coating, certain composition rules in regard to the quantity and kind of inorganic pigments used must be observed and, surprisingly, are different for the sealing layer according to the invention than for the decorative layer. The invention relates, furthermore, to a glass or glass-ceramic article with decorative coatings, produced particularly according to the method of the invention, said article being suitable especially for use as glass-ceramic cooktops.

### CROSS REFERENCE TO RELATED APPLICATIONS

This application claims benefit under 35 U.S.C. §119(a) of German Patent Application No. 10-2008-031-426.9-45, filed Jul. 4, 2008, the entire contents of which are incorporated herein by reference.

### BACKGROUND OF THE INVENTION

1. Field of the Invention

The disclosure relates to a sealing layer for decorative layers on glass or glass-ceramic articles that are subjected to strong thermal and/or chemical and/or mechanical loads as well as a method for producing this sealing layer.

2. Description of Related Art

Glass and, in particular, glass-ceramic articles are often used in hot environments, such as, for example, as a component of cooktops. This leads to high requirements being placed on the temperature stability of materials used for decorative coatings, which comprise a decorative layer and a sealing layer. At the same time, however, other factors, such as, for example, adhesive strength and resistance to scratching as well as impermeability to the penetration of fluids and gases that may arise during use of the article, in addition to factors that arise due to the system, must be taken into account.

Appliance manufacturers place special demands on the adhesive strength of the bonding agent/cooktop system, which also must be fulfilled with a decorative underside coating, comprising a decorative layer and a sealing layer, of cooktops; in particular, the underside coating must not detach from the substrate.

Appliance components of the installed electronics of a cooktop can scrape or scratch on the underside of the glass ceramic, that is, in the case of underside-coated cooktops, directly on the sealing layer.

Moreover, the coating that is produced must be impermeable toward liquid and oil-containing substances, such as are present, for example, in foods. However, certain substances can also arise due to the system and must not have any detrimental effect on the coated glass or glass-ceramic article. Under consideration in this case are, for example, gas-heated glass-ceramic cooktops, in which sulfur oxides, which are formed together with water when gas burns, are converted into an acid, which can attack the substrate as well as the decorative and sealing layer.

Known, for example, are decorative coatings on glass and glass ceramics, used as an underside coating, with and without a sealing layer. In general, a first coloring layer is applied directly on the transparent glass/glass-ceramic article, which is not colored throughout the volume. This first layer has, as a rule, a certain adhesive strength and resistance to scratching. In particular, however, the impermeability to the penetration of liquid or gaseous media is generally insufficient in regard to the high requirements in the field of underside-coated cooktops. For this reason, a two-layer construction is frequently chosen, in which the decorative coating is furnished additionally with a sealing layer.

Known from EP 0729442 is a method for producing functional glass-like, preferably colored or colloidally colored layers on substrates. The functional glass-like layers are produced by hydrolysis and condensation based on a sol-gel process, for example, from hydrolyzable silanes, organosilanes, and optional compounds of glass-forming elements, as well as molecular-disperse or nanoscale function carriers. Mentioned as coloring elements are temperature-stable dyes and pigments, metal or nonmetal oxides, coloring metal ions, metal colloids or metal-compound colloids, and metal ions, which react to form metal colloids under reducing conditions. The coat prepared from a mixture of these components is applied onto a substrate and thermally densified to form a glass-like layer. The quantity of the respectively added function carrier is governed by the desired functional properties of the coating being produced, such as, for example, the desired color intensity or opacity. This method enables crack-free coatings having high thermal, mechanical, and chemical stability to be produced on metal, glass, and ceramic surfaces.

No specific information is provided in regard to adhesive strength, resistance to scratching, and, in particular, the impermeability of the glass-like layers produced, apart from the following statement, which is not further elaborated: “The possibility of thermal densification at relatively high temperatures allows the production of crack-free coatings with high thermal, mechanical, and chemical stability on metal, glass, and ceramic surfaces” (column 2, lines 25-29). The impermeability of the decorative layer or of the sealing layer, when it is used, for example, as an underside coating for glass-ceramic cooktops, is a important criterion for the manufacturers of these articles, because a lack of impermeability during use can cause optical changes up to and including damage to the glass or glass-ceramic substrate.

EP 1218202 describes a method for producing imprinted substrates, in which a printing paste is applied imagewise on a substrate and is densified by thermal treatment (preferably between 400 and 800° C.). This method is suitable for the production of conductive printing pastes, in particular conductive screen printing or serigraphy pastes for imprinting substrates with conductive components, such as, for example, conductive tracks. The printing paste comprises a matrix-forming, polyorganosilane-based condensate, which is obtained by the sol-gel process, and one or more coloring, luminescent, conductive, and/or catalytically active fillers. As substrates, it is possible to employ any thermally stable materials, preferably ceramics, glass ceramics, or glass.

The requirement for thermally stable materials is due to the thermal treatment in the course of the method. No statements are made as to how the layers produced according to the method of the invention are to behave during continuous high temperature load, such as, for example, can occur for the underside coatings of cooktops.

The quantity of coloring, luminescent, and/or catalytically active filler is governed by the desired functional characteristics of the coating, such as, for example, the desired color intensity; not mentioned are criteria of adhesive strength, resistance to scratching, and, in particular, impermeability. The decorative layer is not provided with a sealing layer.

The patent specification DE 10355160 relates to a transparent, uncolored glass/glass-ceramic plate, which is subjected operationally to high thermal loads and which has on its entire surface or a part thereof a visibly opaque, colored, high-temperature-stable coating in the form of an organic/inorganic network structure furnished with coloring pigments. In this case, the inorganic network structure is preferably formed by a sol-gel layer, in which the color pigments and filler particles are incorporated in a pre-specified quantity ratio. The pigment/sol mixing ratio is usually 1:1 in relation to the weight; for well-covering pigments, the proportion may be reduced to 20 wt %.

Mentioned in the exemplary embodiments as possible pigments are spinel-based pigments, oxidic pigments, and zirconium-based pigments, but also mica pigments.

The obtained mixture is applied, as a colored coating, onto the glass/glass-ceramic plate and baked in under thermal conditions that do not lead to any fusing reaction between the colored layer and the coated surface, that is, at relatively low temperatures. Preferably, an oil- and water-impermeable outer sealing layer is applied additionally to the surface of the decorative layer produced.

The layers produced according to the method of the invention shall have, in addition, a sufficient adhesive strength of the layer on the substrate even at temperatures that occur during continuous operation of a cooktop (e.g., 700° C. for 10 h). Surprisingly, it has been found that, in particular, the impermeability of the two-layer construction consisting of decorative layer and sealing layer is crucially dependent on the exact composition of the sealing layer.

DE 10355160 does not take into consideration the relationship between the exact composition of the sealing layer and the “impermeability” of the layer packet, comprising the decorative layer and the sealing layer. It is merely basically explained that an oil- and water-impermeable sealing layer can be applied.

As the discussed prior art shows, a broad color-space spectrum may be fundamentally realized in the production of pigmented layers based on sol-gel and appears to be limited only by the high-temperature-stable pigments that are available. However, in practical implementation, it has been found in many experiments that the layer properties depend in a dramatic way on the pigmentation used. It has thereby surprisingly ensued that a qualitatively high-grade coating of glass-ceramic articles, in particular, is not trivial. Departure from an “optimal” pigment composition of both the decorative layer and the sealing layer results in an overproportional deterioration of the layer properties, particularly in regard to the adhesive strength and the impermeability.

### BRIEF SUMMARY OF THE INVENTION

The invention is therefore based on the problem of providing a sealing layer for decorative layers on glass or glass-ceramic substrates, which has good properties in regard to the adhesive strength between the decorative layer and substrate, on the one hand, and between the decorative layer and the sealing layer, on the other hand, as well as a good impermeability to the penetration of fluids and gases.

This problem is solved in a simple way by the subject of the present application. Advantageous embodiments and further developments are given herein.

The sealing layers for decorative layers on glass or glass-ceramic substrates, in accordance with the invention, are produced by means of a sol-gel process, with at least fillers and inorganic pigments being mixed with the sol-gel. The sol-gel binding agent with the fillers and the pigments for the decorative layer is deposited on at least one side of a glass or glass-ceramic substrate, dried, and subsequently baked in. In a second step, the sol-gel binding agent for the sealing layer is mixed with the fillers and the inorganic pigments and applied on the substrate with the hardened decorative layer and subsequently hardened at elevated temperatures. In this case, the sealing layer that is produced can be translucent, partially transparent, or opaque or covering.

The inorganic decorative pigments used for the sealing layer include flake-form pigment particles and inorganic, preferably non-oxidic solid lubricant, which are added in a ratio of weight percents (wt % of flake-form pigments:wt % of solid lubricant particles) in the range of 10:1 to 1:1, preferably 5:1 to 1:1, and especially preferably 3:1 to 1.5:1. The use of a solid lubricant, in particular in the aforementioned given weight percent ratio, has turned out to be very advantageous in terms of the impermeability of the sealing layer to oily and aqueous fluids. Surprisingly, other composition ratios have markedly poorer properties, not only in regard to the impermeability of the sealing layer, but also, in particular, in regard to the adhesive strength, which represents a key factor in coatings of the kind described.

A glass or glass-ceramic article produced according to the described method accordingly comprises a glass or glass-ceramic substrate, which is furnished with a decorative layer on at least one side, with a decorative layer being covered on its entire surface or on a part thereof by a sealing layer. Both the decorative layer and the sealing layer have a hardened sol-gel binder, which consists essentially of a metal oxide network. This metal oxide network is preferably a SiO₂ network, especially preferably a glassy metal oxide network. Advantageously, in particular in the case of a sealing layer hardened at low temperatures, the decorative layer contains organic residues that are bonded to the metal oxide network. These organic residues lead to appreciably improved water- and oil-repelling properties of the produced layers. According to a preferred enhancement of the invention, the sealing layer contains at least 5% more organic residues, in relation to the number of organic residues, than the decorative layer.

It has been found in experiments that the kind of pigmentation has a decisive influence both on the decorative layer and on the sealing layer, in particular, on the adhesive strength and the impermeability of the decorative coating produced. In accordance with the invention, a layer with “good adhesive strength” is understood to mean that no detachment of the layer takes place in an adhesive tape test based on DIN 58196-6. In this case, differently preconditioned test specimens were employed (e.g., after baking in, after steam loading, quenching, and the like). Alternatively, a crockmeter test based on DIN 58196-5 is carried out, in which, once again, no detachment of the layer may occur. A slight polishing effect due to local smoothing of the layer is permitted, however. A “good impermeability” is defined, in accordance with the acting substances, on the basis of the following tests and relates to a layer packet, which comprises a decorative layer and a sealing layer.

The impermeability of the coating to aqueous and oily media as well as to cleaning agents is defined by means of a droplet test. A droplet of the liquid being tested is applied on the underside coating and allowed to act for different lengths of time, depending on the medium. Water droplets are wiped off after 30 seconds, oil droplets after 24 hours, and cleaning agent or detergent droplets after a few minutes. Subsequently, the glass/glass-ceramic article is evaluated from above through the substrate. The droplet or the shadow of the droplet must not be visible. A penetration of the layer by the applied medium is not permitted. The water droplet test is carried out, moreover, with different preconditioning; in the state as delivered, after annealing, after quenching, after steam loading, etc.

In a further test in regard to the impermeability to oily media, a cut edge of the coating is placed in oil, with the time of action being varied between one and five minutes. Oil must not creep upwards in the layer packet.

The impermeability to adhesive is determined by applying a bead of adhesive on the coating and hardening it there. If necessary, different annealings of the samples prepared in this way are carried out. Subsequently, the glass/glass-ceramic article is evaluated from above through the substrate. The bead of adhesive or its shadow must not be visible. The impermeability to jointing materials is determined analogously, but without the step of hardening. The jointing materials or a shadow, which results from the outgasing of the jointing materials, must not be visible.

Surprisingly, it has been found that the combination of flake-form pigments and inorganic solid lubricants in certain weight ratios leads to exceptionally good adhesive strengths of the decorative layer. A good impermeability of the sealing layer, in conjunction with a good adhesive strength between the decorative and the sealing layer can be achieved, first of all, by using the same pigmentation for the sealing layer as for the decorative layer.

Furthermore, however, even compositions that are unsuitable for the pigmentation of the decorative layer have surprisingly afforded outstanding results in regard to the properties of the sealing layer described previously.

The decorative coating, comprising a decorative layer and a sealing layer, can be applied both on the underside and on the top side of the glass or glass-ceramic substrate; optionally, it can be applied on both sides of the substrate. Both the decorative layer and the sealing layer can be applied on the entire surface.

Advantageously, however, different areas of the substrate may be provided with different decorative layers, so that, for example, the functional surfaces of the cooktops of a heating plate can be distinguished optically from the non-heated areas.

Optionally, it is also possible to provide cooktop areas without a decorative layer and to use these areas, for example, for displays or as sensor areas.

The sealing layers according to the invention can be designed to be either opaque, or visibly dense, or else partially transparent or translucent. Thus, areas that are not to be provided with a decorative layer can nonetheless be sealed, even without being opaque.

Furthermore, in order to save costs, for instance, the sealing layer can also be applied only on partial areas in the case that a sealing of the entire surface is not required.

Opaque sealing layers according to the invention are also suitable for blocking out, for example, a substructure that is not supposed to be visible to the final consumer.

In a preferred embodiment, flake-form pigments are used, the mean length of the largest cross section of which lies in a ratio of 10:1 to 1:3, preferably 8:1 to 1:1, especially preferably 6:1 to 2:1. This advantageous embodiment causes the flake-form pigments to orient themselves essentially parallel to the surface of the substrate. Furthermore, the flake-form pigments have the property that they “interlock with one another.” The roughly parallel orientation of the flakes to the substrate surface, together with the interlocking, leads to an appreciable enhancement in the impermeability effect of the sealing layer. However, the pigmentation of the layer can also contain still other pigments. Preferably, however, the fraction of other pigments does not exceed 15% of the total mass of the pigments.

In this case, it is particularly advantageous when the aspect ratio of the flake-form pigments lies at least at 5:1 and their largest cross-sectional length lies, on average, between 2 and 120 μm, preferably between 10 and 60 μm. In this case, the magnitude of the inorganic flake-form pigments given above is advantageously chosen in such a way that it appreciably promotes the impermeability effect of the sealing layer.

In a preferred embodiment, the flake-form pigments consist of mica flakes and/or borosilicate-based flakes and/or glass flakes, particularly preferably of coated mica flakes and/or metal flakes and/or glass flakes. The flake-form pigments may have different coatings so as to achieve different esthetic appearances. However, it has been shown that, with the exception of a TiO₂ coating, by means of which an esthetic appearance of brushed steel can be created, the differently coated flakes, such as, for example, flakes coated with Fe₂O₃, should not make up more than 10 wt % of the total flake-form pigments. A higher proportion of differently coated flakes can lead to deteriorated layer properties, in particular in regard to the impermeability and adhesive strength.

In experiments, it has been surprisingly found that the mentioned weight ratios between flake-form pigments, inorganic solid lubricant, and optionally other effect pigments should be maintained, because, otherwise, there results a deterioration of, first of all, the impermeability of the stack of layers produced, in particular toward oily fluids, and, subsequently, insufficient the adhesive strength between the decorative layer and the substrate. Larger quantities of other effect pigments impair in an overproportionally strong manner particularly the impermeability and adhesive strength of both the decorative and the sealing layer. The use of absorption pigments different from those mentioned, which are incorporated into the coloring layer in place of the main pigments or as additional effect pigments, also leads to a strong decrease in the layer performance in regard to the properties mentioned.

Inorganic solid lubricants, preferably non-oxidic solid lubricants, are understood in the sense of the invention to refer to pigments that have a very low surface energy, which preferably is similar to or less than that of graphite. Preferably, non-oxides whose surface energy lies at most 20% greater than the surface energy of graphite are used.

In particular, a layer lattice structure, such as, for example, a graphite-like structure has proven to be advantageous, that is, a layer-like structure of the pigments, with individual layers being bonded underneath one another only with low binding forces, which has the consequence that such pigments show a good lubricating behavior.

In addition to graphite, boron nitride and many sulfides, in particular also molybdenum disulfide, among others, exhibit these properties and may be employed alternatively.

In a preferred embodiment, graphite is employed as an inorganic solid lubricant. Preferably, up to 90% of the graphite has a grain size that is smaller than a value in the range of 2 to 50 micrometers, preferably smaller than a value in the range of 6 to 19 μm (=D90). Grain size is understood in the sense of the invention to refer to the largest diameter of the particles.

When graphite is used as an inorganic solid lubricant, different gray hues may be produced by varying the graphite content. The relevant range of color hues that may be produced with graphite as inorganic non-oxide in accordance with the method of the invention is given in the CIELAB color system by the following values:

L: from 85 to 30

a: from −8 to +8

b: from −8 to +8.

In a particularly preferred embodiment, the sealing layer has the same composition as the decorative layer. Advantageously, a single sol-gel binding agent with fillers and pigments may be produced for this embodiment and may then be used both for producing the decorative layer and for producing the sealing layer.

In order to produce other color hues, graphite can be replaced by another solid lubricant at least partially. Conceivable is, among others, boron nitride or sulfides with layer lattice structure, such as MoS₂. If boron nitride is used in addition to or in place of graphite as a solid lubricant, it is especially advantageous when the particle sizes lie between 1 and 100 μm, preferably between 3 and 20 μm, because, just as in the case of graphite, the particle size of the added boron nitride has a great influence on the adhesive strength and impermeability of the sealing layer in the finished glass or glass-ceramic article. In this case, particles that are too large result in poor adhesive strength.

However, good properties in terms of impermeability and adhesive strength of the sealing layer can also be obtained with other pigmentations. The graphite proportion of the pigmentation can be markedly reduced or even entirely dispensed with, for example. Such a pigmentation is appropriate, for example, when the conductance of the coating is to be as low as possible in order, for example, to achieve a sufficient switching reliability with capacitive contact switches. In this case, among other things, it is also possible to use a different inorganic, preferably non-oxidic, solid lubricant or even a mixture of various inorganic non-oxidic solid lubricants, such as, for example, boron nitride. Boron nitride has the advantage that it has only a very low electrical conductance and thus is especially suitable as a pigment for layers that are to be used in connection with capacitive contact switches.

Both the decorative layer and the sealing layer are based on a hardened sol-gel binder, which is produced by hydrolysis and subsequent condensation from at least one organometallic compound, preferably a silicon alkoxide. The use of organometallic compounds has the advantage that the sol-gel binding agent hardens to form a metal oxide network, preferably a SiO₂ network, to which the organic components are bound. In this case, the organic residues or components improve, in an advantageous manner, the water- and oil-repelling properties of the sealing layer, for example. Especially good experience was achieved for simultaneous use of tetraethoxysilane, triethyoxymethylsilane.

Apart from the basic substances described, pigments, fillers, and/or solvents and/or additives are added to the sol-gel binding agent.

As fillers, spherical particles may be added. Pyrogenic silicic acid, which forms small spherical particles, and/or colloidally disperse SiO₂ particles may be added to these in an advantageous manner. Spherical particles as fillers have the effect that the flake-form pigments are oriented predominantly parallel to the surface of the substrate and thus produce an appearance of slightly roughened or brushed metal. Furthermore, it is found that such decorative coatings are markedly more resistant particularly in regard to their resistance to abrasion and scratching.

Especially good results are obtained when the filler fraction does not exceed 40 wt % of the weight of the flake-form pigment(s) in the coating composition. Preferably used are fillers consisting of colloidally disperse SiO₂ particles and/or pyrogenic silicic acid, the fraction of which makes up, in each case, at most 20 wt % of the mass of the flake-form pigment(s). A mixture consisting of the two kinds of filler, which may have different sizes, has proven to be particularly advantageous for the properties of the decorative layer and/or the substrate, such as, for instance, the strength thereof.

In an especially preferred embodiment, the weight fraction of pigment and fillers in the decorative layer and/or the sealing layer is greater than the weight fraction of the solidified or hardened sol-gel binding agent. Preferably, the fraction of sol-gel binding agent in the produced decorative layer and/or sealing layer is at most 40 wt %, preferably at most 30 wt %. These mixing ratios have a positive effect on the porosity and the structure of the decorative layer and/or the sealing layer. It has been found that the layers are more elastic and thus different temperature expansion coefficients of substrate and decorative layer or of decorative layer and sealing layer can be equilibrated. As a result, the detachment of the decorative layer and/or the formation of strength-reducing microcracks in the decorative layer or substrate are prevented.

If the sol is provided with the given pigments and fillers, the gel-like sol-gel binding agent is produced with at least partial evaporation of the solvent that is added and/or that forms in the reaction. In particular, it may contain the alcohol formed during the hydrolysis and/or the alcohol added as solvent. The evaporation of the solvent(s) should take place at least partially after application onto the substrate.

In general, it is possible to apply the mixture, comprising at least the sol, pigments, and filler, onto the substrate by painting, spraying, or dipping. In an especially preferred further development of the invention, the mixture has a pasty consistency, so that it may be used as a screen printing paste. In this case, there exists the possibility of applying the decorative layer either on the entire surface or on part of the surface or also in a laterally structured manner. The application on part of the surface or in a laterally structured manner has the advantage that several decorative layers having different composition and/or esthetic appearance and/or color may be combined in order to create different optical impressions on different areas of the substrate, for example, in order to at least highlight one cooking surface optically from its surroundings. Another embodiment of the invention includes areas, such as, for instance, windows for sensors or displays, that are not furnished with a decorative layer.

Advantageously, once the decorative layer has been applied on the substrate, the condensation reaction of the sol-gel is accelerated by drying, preferably at 100 to 250° C. A gel is formed having a metal oxide network. During baking in, at temperatures of >350° C., water and/or alcohol is eliminated from the gel-like sol-gel binding agent with formation of the solid metal oxide framework, in particular, of the SiO₂ or organically modified SiO₂ framework. In an especially preferred embodiment, the two steps of the method “drying” and “baking in” are combined into a single process with, for example, the use of a roller oven.

In accordance with the invention, the decorative layer that is produced in this manner is covered with a sealing layer in order to optimize the layer properties, in particular, in regard to impermeability to liquid and gaseous substances. Preferably, the applied sealing layer is dried at temperatures of <300° C. in order, on the one hand, to achieve a hardening of the sol-gel matrix, but, on the other hand, also to not completely bake out the organic residues bound to the sol-gel matrix. These organic residues provide for the good sealing action of this layer, because they act to repel water and oil.

Such a barrier or sealing layer is especially advantageous when the produced glass or glass-ceramic article is combustion-heated. For example, this is the case for gas-heated glass-ceramic cooktops. Here, there results the problem that, during the combustion, sulfur oxides can form also. They react with water, which also forms during the combustion, to give acids, which, in turn, can attack the glass ceramics. The sealing layer according to the invention protects both the substrate and the decorative layer in an advantageous manner against this acid attack.

However, with the decorative layer, in connection with the sealing, it is possible in accordance with the invention, to create not only an optically pleasing appearance but, in addition, an article with enhanced durability.

Advantageously, the sealing layer can have the same composition as the decorative layer in terms of both the sol-gel matrix and the inorganic pigments. Such an embodiment makes it possible to simplify the processes, because the steps for producing the sol-gel for the sealing layer can be dispensed with. The same sol-gel as for the decorative layer can be used. This results, in an advantageous manner, in the saving of time and cost.

Another preferred embodiment provides that the decorative layer and the sealing layer have different compositions; in particular, it may be advantageous to choose the graphite content or the lubricant content of the sealing layer to be greater than the graphite content or lubricant content of the decorative layer.

The low or absent conductivity of sealing layers with less graphite or without graphite makes possible the use of such a glass or glass-ceramic article in the field of capacitive touch or contact switches—for example, as the surface of a touchscreen.

A glass-ceramic article according to the invention may, for example, be a glass-ceramic cooktop. In order to obtain a smooth, robust surface and to protect the decorative coating against wear, the decorative coating in the case of a glass-ceramic cooktop is preferably disposed on the underside. Surprisingly, it has been found that the decorative coating can even cover a heating zone of the cooktop, because it is sufficiently thermally conductive and temperature-stable.

The hardened, sol-gel-based, pigmented sealing layers that can be produced in accordance with the invention at lower temperatures in comparison to the decorative layer are characterized in relation to equivalently pigmented, sol-gel-based decorative layers by a lower porosity. Both the decorative layer and the sealing layer are, in general, microporous with mean pore diameters, determined by the BJH method on the basis of absorption, of less than 2 nanometers, especially less than 1.5 nanometers.

If the internal surface area is determined by multipoint BET analysis with nitrogen absorption, values of less than 50 m²/gram can generally be measured for the sealing layer. Typical values of very good sealing layers lie at 10-40 m²/gram. In contrast to this, equivalent decorative layers exhibit typical values of 200-300 m²/gram.

The cumulative adsorptive pore volume, measured by using the BJH method, lie typically at less than 0.08 cubic centimeters per gram for the sealing layers according to the invention. Thus, for example, a value of 0.048 cubic centimeter per gram was measured on a sealing layer with very good sealing properties. In contrast to this, the cumulative adsorptive pore volume of an equivalent decorative layer typically lies at greater than 0.1 cubic centimeter per gram. Thus, a cumulative pore volume of 0.18 cubic centimeter per gram was measured on a well-adhering decorative layer with a pigmentation such as the sealing layers according to the invention also have.

In the following, the invention will be explained in greater detail on the basis of exemplary embodiments and with reference to the drawings. Identical and similar elements are provided with the same reference numbers; the features of different exemplary embodiments may be combined with one another.

### BRIEF DESCRIPTION OF THE SEVERAL VIEWS OF THE DRAWINGS

FIG. 1 is a schematic cross section through a glass or glass-ceramic substrate having a decorative layer and a sealing layer according to the invention, with the decorative layer and the sealing layer having the same composition;

FIG. 2 is a schematic cross section through a variant of the example shown in FIG. 1, and

FIG. 3 is a plan view of a glass-ceramic cooktop, which is provided with a sealing layer according to the invention and a decorative layer.

### DETAILED DESCRIPTION OF THE INVENTION

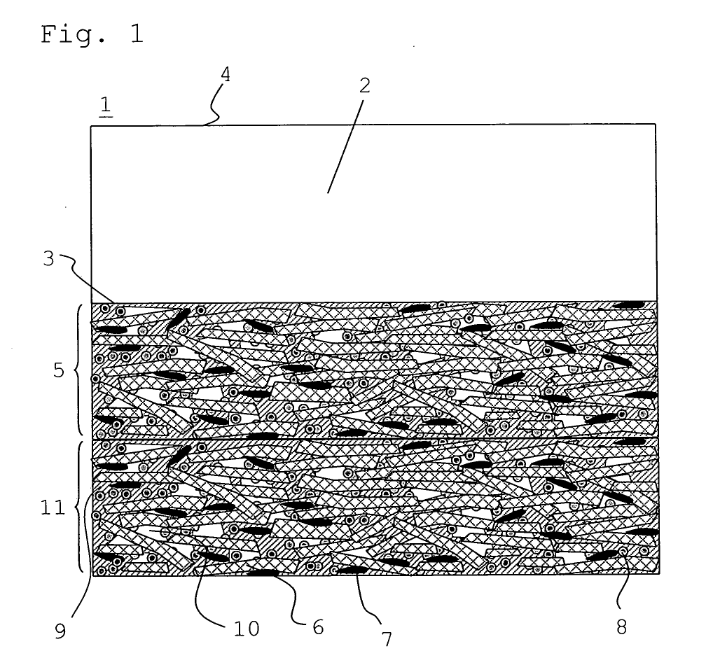

Illustrated in FIG. 1 is a schematic cross section through a glass or glass-ceramic article 1 with a decorative layer and a sealing layer in accordance with the invention. The glass or glass-ceramic article 1, in this example, comprises a glass or glass-ceramic substrate 2 having an underside 3 and a top side 4. The article 1 can be, in particular, a glass-ceramic cooktop. Applied on one of the sides 3 or 4 is a decorative layer 5, which has a pigment composition according to the invention. If the article 1 involves a glass-ceramic cooktop, then the decorative layer 5 is deposited, especially preferably, on the underside 3 of the cooktop so as to prevent wear of the layer from occurring due to use. The sealing layer 11 according to the invention has the same composition as the decorative layer 5.

For producing the decorative layer 5, decorative pigments 6, 7 and fillers 8 are mixed with a sol and the resulting gel-like sol-gel binding agent is hardened on the glass or glass-ceramic substrate 2 by baking in. In the process, a decorative layer 5 having a microporous composite structure of large internal surface area is formed.

The decorative pigments used according to the invention comprise flake-form pigments 6 and graphite 7, which are present in a weight ratio in the range of 10:1 (10 parts of flake-form pigment particles to 1 part of solid lubricant) to 1:1. Used as flake-form pigments are preferably mica flakes and/or borosilicate-based flakes, especially preferably coated mica flakes and/or borosilicate-based flakes and/or glass flakes and, particularly preferably, TiO₂-finished coated mica flakes and/or coated borosilicate-based flakes and/or coated glass flakes. The flake-form pigments preferably have a cross section that lies between 5 and 125 μm, while the D90 value of the graphite preferably lies in the range of 6 to 19 μm.

In a particular embodiment, it is also possible to employ synthetic mica pigments as flake-form pigments. In a further preferred embodiment, the flake-form mica pigments can be coated with cobalt oxide and iron oxide.

Besides the decorative pigments 6, 7, filler particles 8 are additionally present in the layer 5. The filler particles 8 and the decorative pigment particles 6, 7 are bonded together through a hardened sol-gel binding agent 9 to form a solid layer, with the weight fraction of pigment particles 6, 7 and filler particles 8 being greater than the weight fraction of the solidified and hardened sol-gel binding agent 9. Preferably, in the case of a decorative layer 5 as shown in FIG. 1, the fraction of sol-gel binding agent 9 is at most 40 wt % or even only at most 30 wt % of the total mass of the layer 5. Pores 10 remain present due to the high solids fraction or due to the low fraction of sol-gel binding agent 9. The overall porous layer is relatively flexible, so that differences in the temperature expansion coefficients of substrate 2 and decorative layer 5 can be equilibrated.

A gel-like sol-gel binding agent, to which the different pigment mixtures described below are added, can be prepared as follows:

A mixture of tetraethoxyorthosilane (TEOS) and triethoxymethylsilane (TEMS) is prepared, it being possible to add alcohol as a solvent. An aqueous metal oxide dispersion, in particular a SiO₂ dispersion in the form of colloidally disperse SiO₂ particles, is mixed with acid, preferably hydrochloric acid or a different mineral acid, such as sulfuric acid. The two separately prepared mixtures can be stirred for an improved homogenization. Subsequently, the two mixtures are combined and mixed.

Advantageously, this mixture is allowed to age for one hour, for example, preferably under constant stirring. In parallel to the preparation of this mixture, the pigments and optionally additional fillers, preferably pyrogenic silicic acid, may be weighed, added to the aging mixture, and dispersed. The pyrogenic silicic acid and/or the colloidal SiO₂ dispersion afford(s) the spherical filler particles 8 for the finished decorative layer 5. Here, the fraction of fillers in each case is less than 20 wt % of the mass of the flake-form pigment(s) 6, 7. Overall, the weight fraction of filler particles 8 in this case is preferably at most 10 wt % of the weight fraction of the pigment particles 6, 7.

Depending on the planned type of application on the substrate, different solvents, rheological additives, and other additives may be added to the mixture.

The sol is transformed through evaporation of the alcohol and through poly-condensation of the hydrolyzed TEOS and TEMS into a metal oxide gel. This process is accelerated after application of the mixture onto the substrate 2 by drying at temperatures of between 100 and 250° C., so that the applied layer solidifies to form the gel. If, for example, TEOS and/or TEMS are used as educts, a SiO₂ network is formed, in particular also an at least partially methyl-substituted SiO₂ network. The subsequent baking in of the dried layer at temperatures of preferably >350° C. concludes the reaction to form the SiO₂ network and leads to a densification of the decorative layer 5 thus produced.

In the exemplary embodiment illustrated in FIG. 1, the flake-form pigment particles 6 are predominantly oriented parallel to the surface of the substrate. A predominantly parallel orientation is understood according to the invention to mean that the angle distribution of the surface normals of the pigment particles 6 is not random, but rather has a clear maximum in the direction of the surface normals of the substrate surface. This ordering of the pigment particles is achieved in an especially simple manner by the use of fillers 8 having spherical geometry. The ordering of the flake-form pigment particles 6 has the advantage that the metallic effect is enhanced and the produced decorative layer 5 has, moreover, an improved resistance to scratching and abrasion.

In the exemplary embodiment illustrated in FIG. 1, the decorative layer 5 is additionally covered with a sealing layer 11 according to the invention. In the simplest case, the sealing layer 11 has the same composition as the decorative layer 5 and can thus also be produced by means of an equivalent method. This results in savings in cost and time.

Described in the following will be pigment compositions that make possible especially good layer properties in terms of the decorative layer produced. In a preferred exemplary embodiment, this composition is, at the same time, the composition of the sealing layer according to the invention:

The pigmentation “black” contains 67 weight percent of calcium aluminum borosilicate, coated with: silicon oxide, titanium oxide, stannic oxide (flake-form pigment), and 33 weight percent of high-crystalline graphite with a D90 value of 5-8 micrometers (graphite). Excellent layer properties are achieved with this mixture in terms of adhesive strength and resistance to scratching as well as impermeability of the coating. The decorative layer is dark gray in color and shows a metallic effect. In connection with a suitable sealing layer, all criteria for use of this pigment mixture in decorative underside coating of a cooking surface are fulfilled.

In connection with a suitable sealing layer, a decorative layer with this pigmentation fulfills the requirements in regard to adhesive strength, impermeability, and resistance to scratching that are placed on a glass-ceramic cooktop, for example.

In accordance with a first formulation for the pigmentation of a sealing layer according to the invention, 70 weight percent of a flake-form, TiO₂— and SnO₂-coated, mica-based effect pigment having a particle size in the range of 10 to 60 micrometers and 6 weight percent of another flake-form, mica-based effect pigment, coated with TiO₂, Fe₂O₃, and SnO₂ and having a particle size in the range of 5 to 25 micrometers, are combined with 24 weight percent of high-crystalline graphite with a D90 value of 15 to 20 micrometers. This pigmentation can also be used to produce a decorative layer. In particular, the coating can be constructed using the same formulation for the decorative layer and the sealing layer.

According to a second formulation for the pigmentation of a sealing layer according to the invention, 63 weight percent of a flake-form, TiO₂— and SnO₂-coated, mica-based effect pigment having a particle size in the range of 10 to 60 micrometers and 5 weight percent of another flake-form, mica-based effect pigment, coated with TiO₂, Fe₂O₃, SiO₂, and SnO₂ and having a particle size in the range of 5 to 25 micrometers, are combined with 32 weight percent of high-crystalline graphite with a D90 value of 5 to 8 micrometers. This pigmentation can also be used to produce a decorative layer. In particular, the coating can be constructed using the same formulation for the decorative layer and the sealing layer.

According to a third formulation for the pigmentation of a sealing layer according to the invention, 63 weight percent of a flake-form, cobalt oxide- and iron oxide-coated, synthetic, mica-based effect pigment having a particle size in the range of 5 to 60 micrometers and 3 weight percent of another flake-form, mica-based effect pigment, coated with TiO₂, Fe₂O₃, SiO₂, and SnO₂ and having a particle size in the range of 10 to 120 micrometers, are combined with 32 weight percent of high-crystalline graphite with a D90 value of 5 to 8 micrometers. This pigmentation can also be used to produce a decorative layer. In particular, the coating can be constructed using the same formulation for the decorative layer and the sealing layer.

The three exemplary embodiments above can also obviously be combined with one another, with one of the formulations being employed for producing the decorative layer and the other formulation being employed for producing the sealing layer.

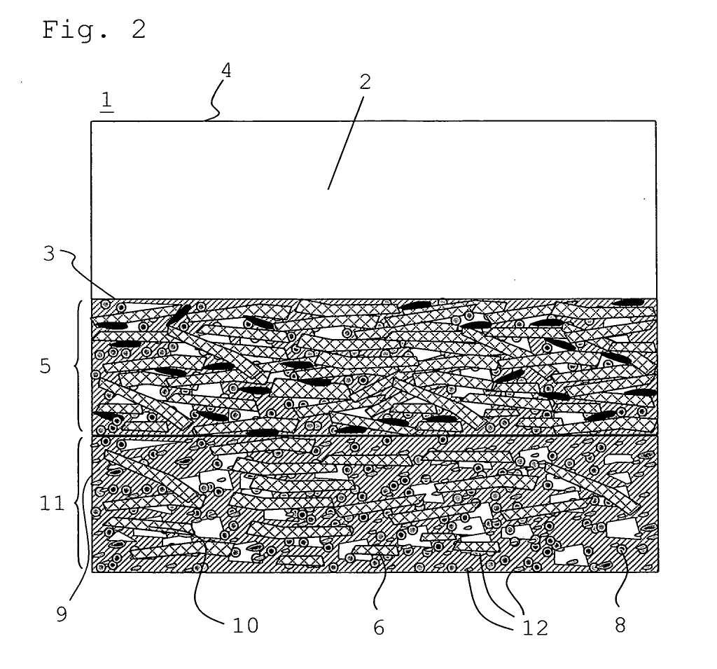

FIG. 2 shows a schematic cross section through a glass or glass-ceramic article 1 according to the invention, consisting of a glass or glass-ceramic substrate 2 with a decorative layer 5 and a sealing layer 11 according to the invention. The decorative layer 5 and the sealing layer 11 are produced in analogy to the method depicted for FIG. 1.

Just like the exemplary embodiment shown in FIG. 1, the sealing layer 11 can generally contain, in addition, also TiO₂ pigments of differing particle size, the particle sizes lying advantageously in a range between 50 and 350 nm. These additional pigments need not be flake-form.

Used as solid lubricant in contrast to the example shown in FIG. 1 are boron nitride particles 12. A sealing layer 11 that has such a pigment composition makes possible applications in fields in which an electrical conductivity of the layer is not desired. An article with such a coating can be employed, for example, in the field of touchscreens.

Given as example below is a pigmentation with which layers based on sol-gel with boron nitride as a solid lubricant can be produced: 35 wt % boron nitride powder having a D50 value of 7 micrometers and a specific surface area of 4 to 6 square meters per gram, 5 wt % of flake-form, mica-based, TiO₂—, Fe₂O₃—, and SnO₂-coated effect pigment with a particle size in the range of 5 to 25 micrometers, and 60 wt % of flake-form, TiO₂— and SnO₂-coated, mica-based effect pigment with a particle size in the range of 10 to 60 micrometers.

Excellent layer properties are obtained in terms of adhesive strength, resistance to scratching, and impermeability of the coating. In connection with a suitable sealing layer, outstanding layer properties are also achieved in terms of impermeability of the layer as well as the overall performance in a cooking surface.

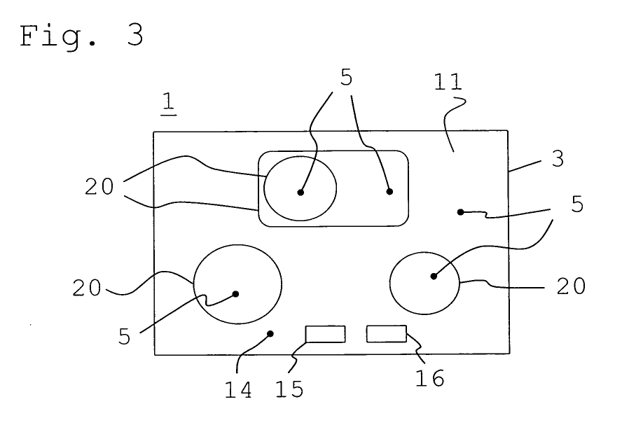

FIG. 3 shows a plan view of a glass-ceramic article 1 coated according to the invention in the form of a glass-ceramic cooktop. The decorative layer 5, provided with a sealing layer 11, is situated on the underside 3 of the glass-ceramic cooktop 2. The cooktop 2 has several heating zones or heating areas 20, under which the heating elements (not illustrated) are arranged. The heating zones 20 can be delimited from the non-heatable surroundings 14, for example, by decorative layers 5 having different gray coloration and/or esthetic appearance and/or composition. These can have an esthetic function or also a function that identifies the heating zones 20. Advantageously, it is also possible to leave blank areas without a decorative layer 15 and/or without a sealing layer 16, so that these areas can be used, for example, as sensor fields and/or also for a display.

The decorative layer 5 and the sealing layer 11 with the pigmentations according to the invention are not only sufficiently temperature-stable, but also capable of well conducting the heat produced by the heating elements for cooking on the cooktop. It has been found, in particular, that the decorative coating in the hot areas 20 does not change its optical appearance even after long operation.

It is obvious to the person skilled in the art that the invention is not limited to the exemplary embodiments described above, but rather can be varied in diverse ways. In particular, the features of the individual exemplary embodiments can also be combined with one another.

1-21. (canceled)

22. A glass or glass-ceramic article, comprising:
a glass or glass-ceramic substrate;
a decorative layer on at least one side of the glass or glass-ceramic substrate;
a sealing layer covering the decorative layer, wherein the sealing layer comprises at least one hardened sol-gel binding agent and inorganic decorative pigments, wherein the hardened sol-gel binding agent comprises organic components bound to the hardened sol-gel binding agent, the organic components being water-repelling and oil-repelling, and wherein the inorganic decorative pigments comprise flake-form pigment particles and inorganic solid lubricant particles in a ratio of 10:1 to 1:1 wt %.

23. The glass or glass-ceramic article according to claim 22, wherein the sealing layer further comprises fillers.

24. The glass or glass-ceramic article according to claim 22, wherein the ratio lies in the range of 5:1 to 1:1 wt %.

25. The glass or glass-ceramic article according to claim 22, wherein the ratio lies in the range of 3:1 to 1.5:1 wt %.

26. The glass or glass-ceramic article according to claim 22, wherein the flake-form pigment particles have a ratio of a mean length of the largest cross section to a thickness of the sealing layer which lies in the range of 10:1 to 1:3.

27. The glass or glass-ceramic article according to claim 22, wherein the flake-form pigment particles have an aspect ratio that is at least at 5:1 and have a largest cross section between 2 and 120 μm.

28. The glass or glass-ceramic article according to claim 22, wherein the flake-form pigment particles comprise particles selected from the group consisting of mica flakes, borosilicate-based flakes, glass flakes, coated mica flakes, coated borosilicate-based flakes, coated glass flakes, and combinations thereof.

29. The glass or glass-ceramic article according to claim 22, wherein the flake-form pigment particles comprise TiO₂-coated flake-form pigments.

30. The glass or glass-ceramic article according to claim 22, wherein the inorganic solid lubricant comprises lubricants selected from the group consisting of graphite, boron nitride, inorganic non-oxide, and combinations thereof.

31. The glass or glass-ceramic article according to claim 22, wherein the decorative layer covers only a part of the at least one side of the glass or glass-ceramic substrate, the sealing layer covering at least surfaces of the glass or glass-ceramic substrate not covered by the decorative layer.

32. The glass or glass-ceramic article according to claim 22, wherein the decorative layer comprises inorganic decorative pigments comprising flake-form pigment particles and inorganic solid lubricant particles having the same weight ratio and the same composition as the sealing layer.

33. The glass or glass-ceramic article according to claim 32, further comprising a SiO₂-containing metal oxide network in the sealing layer and the decorative layer.

34. The glass or glass-ceramic article according claim 22, wherein the decorative layer comprises a hardened sol-gel binding agent, and wherein the hardened sol-gel binding agent of the decorative and sealing layers comprises a metal oxide network.

35. The glass or glass-ceramic article according claim 34, wherein the metal oxide network comprises a SiO₂-containing metal oxide network.

36. The glass or glass-ceramic article according to claim 22, wherein the decorative layer is laterally structured so that surfaces of the glass or glass-ceramic substrate not covered by the decorative layer are covered by the sealing layer.

37. The glass or glass-ceramic article according to claim 22, wherein the sealing layer and the decorative layer are arranged on an underside of the glass-ceramic substrate.

38. The glass or glass-ceramic article according to claim 22, wherein the sealing layer covers at least one heating zone of a cooktop.
